(19) United States
(12) Patent Application Publication
(10) Pub. No.: US 2026/0149153 A1
(43) Pub. Date: May 28, 2026

(54) DESIGN AND METHOD OF RECHARGEABLE ENERGY STORAGE SYSTEM COVER WITH ACCESS HOLES AND SEALING PLUGS

(71) Applicant: GM Global Technology Operations LLC, Detroit, MI (US)

(72) Inventors: Steven Cipriano, Chesterfield Township, MI (US); Anthony Michael Coppola, Rochester Hills, MI (US)

(73) Assignee: GM Global Technology Operations LLC, Detroit, MI (US)

(21) Appl. No.: 18/960,325

(22) Filed: Nov. 26, 2024

(51) Int. Cl. H01M 50/645; B60L 50/64; H01M 50/258; H01M 50/276; H01M 50/28; H01M 50/282; H01M 50/588

(52) U.S. Cl. CPC H01M 50/645; B60L 50/64; H01M 50/258; H01M 50/276; H01M 50/28; H01M 50/282; H01M 50/588; H01M 2220/20

(57) ABSTRACT

A rechargeable energy storage system (RESS) assembly includes a battery module, a casing, a potting material, and a plug. The casing accommodates the battery module within a cavity of the casing. The casing includes a shell and a cover joined to the shell to define the cavity. The cover extends over and along at least a portion of the cavity. The cover includes a cover body and a port extending through the cover body and is configured to fluidically couple the cavity and exterior of the casing. The potting material is injected into the cavity through the port. The potting material flows within the cavity and between the cover and the battery module. The plug is disposed within the port of the cover and hermetically seals the cavity from exterior of the casing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a rechargeable energy storage system (RESS) for a vehicle.

Assembling the RESS prior to installation at the vehicle may be tedious and cumbersome. In many instances, battery modules are disposed within a pack or enclosure of the RESS, wherein the enclosure generally includes a lower portion and an upper portion or cover joined together to accommodate the battery modules within the enclosure. Sealing and securing the battery modules within the enclosure is critical for proper operation of the RESS. For example, sealing the battery modules within the enclosure of the RESS may prevent gases or other materials from escaping the enclosure through unintended pathways. Furthermore, securing the battery modules within the enclosure protects the battery modules from movement during operation of the vehicle. Often, an expanding foam is disposed within the enclosure to fill gaps between the battery modules and substantially fill the enclosure.

The expanding foam is typically located in the enclosure prior to sealing the upper portion of the enclosure to the lower portion of the enclosure to ensure that the expanding foam is positioned within all necessary gaps within the enclosure. In so doing, however, the expanding foam may expand over an edge of the lower portion of the enclosure, especially if installation of the upper portion of the enclosure is delayed. The expanded foam located at or over the edge may prevent the upper portion of the enclosure from sufficiently and fully sealing to the lower portion of the enclosure, thus preventing the battery modules from being fully sealed within the enclosure. In other words, gaps, cavities, or leak-points may form between the lower portion of the enclosure and the upper portion of the enclosure, thus preventing the enclosure from being fully sealed and, thus, preventing the enclosure from being air-tight and water-tight. Gaps, cavities, and leak-points may also develop if the upper portion of the enclosure is not properly aligned relative to the lower portion of the enclosure. Properly aligning the upper portion of the enclosure relative to the lower portion of the enclosure may be challenging due to the size and configuration of the upper portion of the enclosure and the lower portion of the enclosure, combined with the short amount of time available to install the upper portion of the enclosure to the lower portion of the enclosure before the expanding foam seeps over the edge of the lower portion of the enclosure. Further, a significant amount of time may be required to firmly press and hold the upper portion of the enclosure against the lower portion of the enclosure during installation. The cumbersome and tedious process of sealing the battery modules within the enclosure includes many risks of the process ultimately being unsuccessful.

### SUMMARY

One aspect of the disclosure provides a rechargeable energy storage system (RESS) assembly. The RESS assembly includes a battery module, a casing, a potting material, and a plug. The casing accommodates the battery module within a cavity of the casing. The casing includes a shell and a cover joined to the shell to define the cavity. The cover extends over and along at least a portion of the cavity. The cover includes a cover body and a port extending through the cover body and configured to fluidically couple the cavity and exterior of the casing. The potting material is injected into the cavity through the port. The potting material flows within the cavity and between the cover and the battery module. The plug is disposed within the port of the cover and hermetically seals the cavity from exterior of the casing.

Implementations of this aspect of the disclosure may include one or more of the following optional features. In some examples, the cover body includes an outer panel, an inner panel, and a core disposed between the outer panel and the inner panel. In some further examples, the outer panel and the inner panel include a metallic material and the core includes a composite material. In some even further examples, the plug includes the composite material, the plug configured to hermetically seal the port of the cover via friction welding between the plug and the composite material of the core of the cover body. In some other even further examples, the plug includes the metallic material, the plug configured to hermetically seal the port of the cover via friction welding between the plug and the metallic material of at least one of the outer panel and the inner panel. In some other further examples, the inner panel of the cover includes a flow channel extending from the port for guiding the flow of potting material injected into the cavity.

In some implementations, the cover body includes a metallic material. In some further implementations, the plug includes the metallic material, the plug configured to hermetically seal the port of the cover via mechanical fastening between the plug and the metallic material of the cover.

In some configurations, the port includes a plurality of ports extending through the cover body at discrete locations, and wherein the plug includes a plurality of plugs, each individual plug of the plurality of plugs disposed within a corresponding port of the plurality of ports to hermetically seal the cavity.

In some examples, the cover is welded to the shell.

Another aspect of the disclosure provides a vehicle. The vehicle includes a rechargeable energy storage system (RESS) assembly. The RESS assembly includes a battery module, a casing, a potting material, and a plug. The casing accommodates the battery module within a cavity of the casing. The casing includes a shell and a cover joined to the shell to define the cavity. The cover extends over and along at least a portion of the cavity. The cover includes a cover body and a port extending through the cover body and is configured to fluidically couple the cavity and exterior of the casing. The potting material is injected into the cavity through the port. The potting material flows within the cavity and between the cover and the battery module. The plug is disposed within the port of the cover and hermetically seals the cavity from exterior of the casing.

Implementations of this aspect of the disclosure may include one or more of the following optional features. In some examples, the cover body includes an outer panel, an inner panel, and a core disposed between the outer panel and the inner panel. In some further examples, the outer panel and the inner panel include a metallic material and the core includes a composite material. In some even further examples, the plug includes the composite material, the plug configured to hermetically seal the port of the cover via friction welding between the plug and the composite material of the core of the cover body.

In some implementations, the cover body and the plug include a metallic material, the plug configured to hermetically seal the port of the cover via mechanical fastening between the plug and the cover.

Yet another aspect of the disclosure provides a method of manufacturing a rechargeable energy storage system (RESS) assembly. The method includes (i) disposing a battery module within a cavity of a casing, the casing including a cover and a shell, (ii) joining the cover of the casing to the shell of the casing to accommodate the battery module within the cavity of the casing, the cover extending over and along at least a portion of the cavity and including a cover body and a port extending through the cover body and fluidically coupling the cavity and exterior of the casing, (iii) injecting potting material into the cavity via the port of the cover, the potting material flowing within the cavity and between the cover and the battery module, and (iv) disposing a plug within the port of the cover to hermetically seal the cavity from exterior of the casing.

Implementations of this aspect of the disclosure may include one or more of the following optional features. In some examples, the cover body includes an outer panel, an inner panel, and a core disposed between the outer panel and the inner panel. In some further examples, the outer panel and the inner panel include a metallic material and the core includes a composite material. In some even further examples, the plug includes the composite material, the plug hermetically sealing the port of the cover via friction welding between the plug and the composite material of the core of the cover body.

In some implementations, the cover body and the plug include a metallic material, the plug hermetically sealing the port of the cover via mechanical fastening between the plug and the cover.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a rechargeable energy storage system (RESS) assembly according to the present disclosure;

FIG. 2A is a perspective view of the RESS assembly of FIG. 1 with a cover uninstalled from a shell of the RESS assembly;

FIG. 2B is a perspective view of the RESS assembly of FIG. 2A with the cover joined to the shell and enclosing a battery module within a cavity of the RESS assembly;

FIG. 3 is a top view of the cover of the RESS assembly of FIG. 2A;

FIG. 4 is a cross-sectional view of the RESS assembly of FIG. 2B including a potting injector positioned at a port of the cover;

FIG. 5 is a cross-sectional view of the RESS assembly of FIG. 2B including a plug disposed within the port of the cover and potting material disposed within the cavity;

FIG. 6 is a flowchart of an example method of assembling the RESS assembly;

FIG. 7 is cross sectional view of another RESS assembly according to the present disclosure and including a potting injector positioned at a port of a cover of the RESS assembly; and

FIG. 8 is a cross-sectional view of the RESS assembly of FIG. 7 including a plug disposed within the port of the cover and potting material disposed within a cavity of the RESS assembly.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

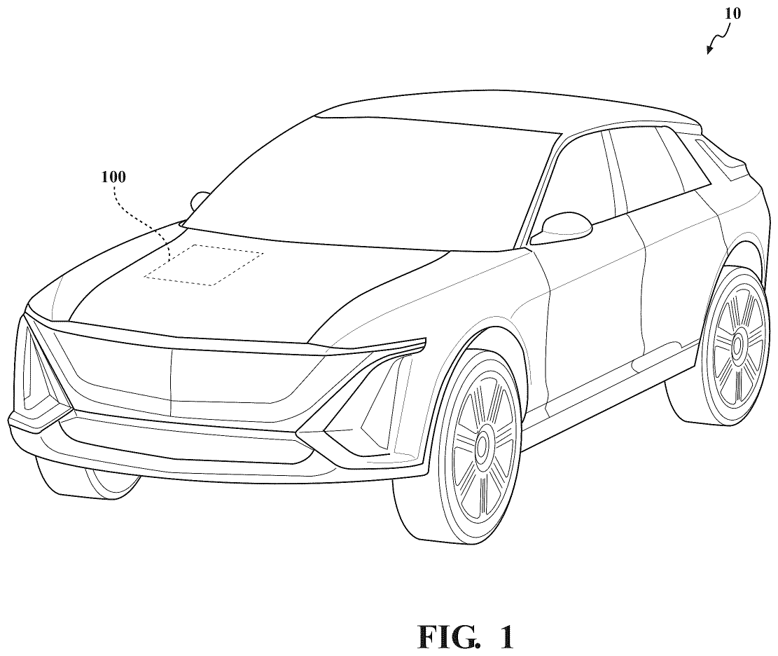

With reference to FIGS. 1-5, a vehicle 10, such as an electric vehicle (EV) or plug-in hybrid vehicle (PHEV) or a hybrid vehicle, includes a rechargeable energy storage system (RESS) assembly 100 configured to store, recharge, and provide electrical power to components included at the vehicle 10. For example, the RESS assembly 100 may include a lithium-ion battery assembly. The RESS assembly 100 may at least partially power a propulsion system of the vehicle 10. In this regard, when installed at the vehicle 10, energy stored at the RESS assembly 100 may enable the propulsion system to drive or power the vehicle 10.

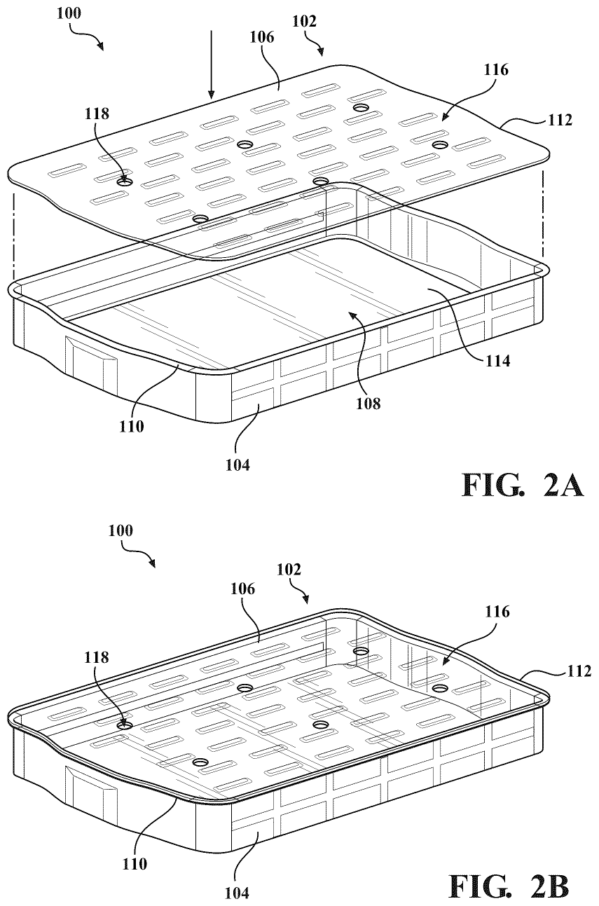

The RESS assembly 100 includes a casing or a housing or an enclosure 102 for mounting the RESS assembly 100 at the vehicle 10 and protecting electronic components of the RESS assembly 100 (FIGS. 2A and 2B). The casing 102 includes a lower portion or a shell 104 and an upper portion or a cover 106 wherein the cover 106 is joined and sealed to the shell 104 to define a cavity 108 within the casing 102. For example, a perimeter region 110 of the shell 104 may be joined, such as via welding, and sealed to a perimeter region 112 of the cover 106, thus creating an air-tight and water-tight seal between the shell 104 and the cover 106. The cover 106 may be joined to the shell 104 in any suitable manner, such as via adhesive material disposed between the perimeter region 110 of the shell 104 and the perimeter region 112 of the cover, via mechanical fasteners (e.g., bolts, rivets, and the like), and the like.

One or more battery modules 114 are disposed within the cavity 108 of the casing 102. In this regard, the cover 106 extends over and along both the battery modules 114 and at least a portion of the cavity 108. Both the shell 104 and the cover 106 include rigid materials that prevent deformation of the casing 102 and prevent collapsing of the cavity 108, such as a metallic material (e.g., steel), a composite material (e.g., a fiber-reinforced resin) or a combination of metallic materials and composite materials. For example, the cavity 108 may be vacuum-sealed when the RESS assembly 100 is fully assembled and installed at the vehicle 10, thus imposing a risk of the cavity 108 collapsing due to differences in pressure between the cavity 108 and external of the casing 102. In another example, the casing 102 may experience vibrations, turbulence, or other minor movements during operation of the vehicle 10, such as when the vehicle 10 travels along a rough or uneven road, thus imposing a risk of the casing 102 deforming. Moreover, the shell 104 and the cover 106 may protect the battery modules 114 and other electronic components of the RESS assembly 100 during vehicle collisions and other impacts. Maintaining rigidity of the casing 102 concurrently maintains sealing of the cover 106 to the shell 104.

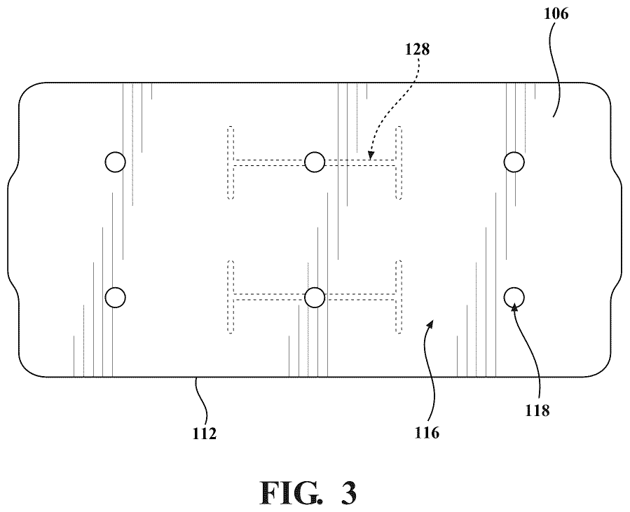

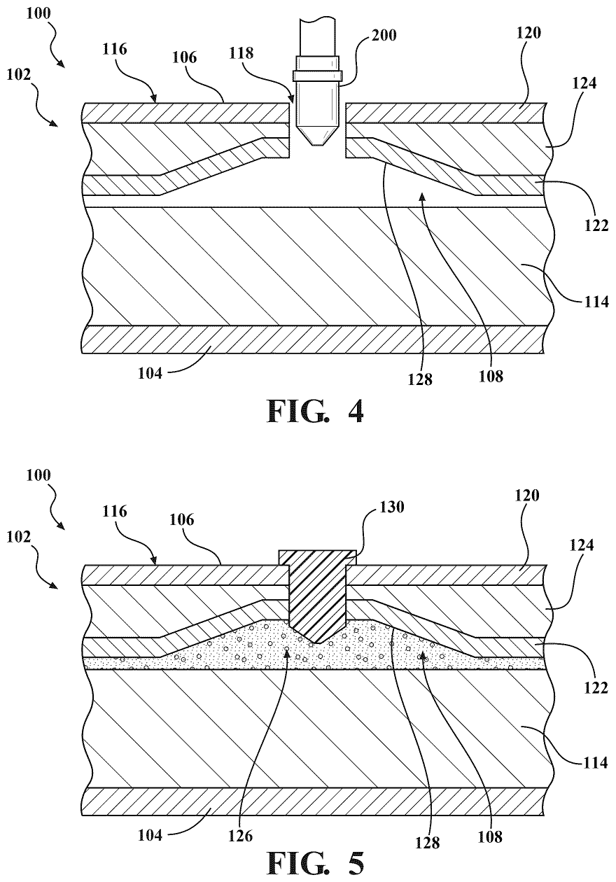

The cover 106 includes a cover body 116 forming a substantially planar panel over the cavity 108 of the casing 102 and a channel or port 118 extending through the cover body 116 and configured to fluidically couple the cavity 108 and exterior of the casing 102 when uncovered or unsealed (FIGS. 3 and 4). In other words, the port 118 provides access to the cavity 108 once the cover 106 has been sealed to the shell 104. Further, the port 118 provides access to the battery module 114 disposed at the cavity 108. The cover 106 may include any suitable number of ports 118 depending on the configuration of the RESS assembly 100, and as discussed further below. The configuration of the RESS assembly 100 may vary based on the vehicle 10 at which the RESS assembly 100 is installed. In the illustrated examples, the port 118 includes six ports 118 extending through the cover body 116 and arranged at discrete locations at the cover 106. However, it should be appreciated that the port 118 may include less ports 118 or more ports 118 without deviating from the context of this disclosure.

The cover body 116 may include multiple varieties of material while simultaneously maintaining rigidity. For example, the cover body 116 may include an outer skin or outer panel 120 and an inner skin or inner panel 122 opposite the outer panel 120. The outer panel 120 faces exterior of the casing 102, while the inner panel 122 faces the cavity 108. Both the outer panel 120 and the inner panel 122 include a metallic material, such as steel, aluminum, or something of the like. The metallic material of the outer panel 120 and the inner panel 122 offers structural durability, strength, and rigidity to the cover 106. The cover body 116 may also include a core 124 disposed between the outer panel 120 and the inner panel 122. The core 124 includes a composite material and may be entirely enclosed by the outer panel 120 and the inner panel 122. The composite material of the core 124 provides added strength, weight reduction, and noise reduction to the cover 106. Further, the composite material of the core 124 may thermally insulate the cavity 108 of the RESS assembly 100.

The RESS assembly 100 also includes a potting material 126 that is injected through the one or more ports 118 to substantially fill cavities and gaps between the battery modules 114 and the cover 106 within the cavity 108 (FIGS. 4 and 5). The potting material 126 may be an expandable foam, a thermosetting chemically blown foam, or something of the like. In this regard, the potting material 126 is configured to expand as it cures and hardens. In other words, the potting material 126 cures from a flowing liquid to a hardened solid over a period of time. The potting material 126 is disposed within the cavity 108 between the cover 106 and the battery module 114 and cures within the cavity 108. Further, the potting material 126 may surround and encapsulate the battery module 114 as the potting material 126 flows (prior to curing) within the cavity 108, thus further securing and insulating the battery module 114 within the casing 102. The potting material 126 is configured to be injected into the cavity 108 through the port 118 of the cover 106 via a potting injector 200, the details of which will be described in greater detail below.

Thus, the positions of the respective ports 118 at the cover 106 may correspond to gaps and spaces and other desired locations of the potting material 126 within the cavity 108. For example, the ports 118 may be arranged across the cover 106 in a substantially uniform manner (i.e., with substantially equal spacing between adjacent ports 118) to provide uniform or equal fill of potting material 126 when injected through the ports 118. Optionally, the ports 118 may be arranged at or near portions of the RESS assembly 100 known to have larger volumes of empty space within the cavity 108, such as at or near the perimeter of the RESS assembly 100, at or near smaller portions of the battery modules 114 or portions lacking battery components, and the like. During injection of the potting material 126 a vacuum source may be connected to the cavity 108 of the RESS assembly 100 (such as at one of the ports 118) to encourage flow of potting material 126 within the cavity 108 and substantially fill the volume of the RESS assembly 100.

To assist in the flow of the potting material 126 within the cavity 108, the inner panel 122 of the cover body 116 may include one or more flow channels 128 extending at or near the port 118 (FIGS. 3-5). That is, the flow channel 128 extends along the inner panel 122 from the port 118 and may guide the flow of the potting material 126 that is injected into the cavity 108 to better direct and spread the flow of the potting material 126. Guiding the flow of the potting material 126 allows the potting material 126 to be deliberately directed into certain areas of the cavity 108, or certain areas of the battery module 114, based on the configuration of the flow channel 128. For example, the flow channel 128 may be recessed within the inner panel 122 in an “H” shape, as seen in the illustrated example. The “H” shape allows the potting material 126 to flow along or within or relative to the “H” shape, thus directing it to specific areas within the cavity 108 before curing begins. It should be appreciated that the shape and configuration of the flow channel 128 may vary without deviating from the context of this disclosure. Further, the plurality of ports 118 may correspond to a plurality of flow channels 128, wherein each port 118 included at the cover 106 may correspond to each of the flow channels 128 at the inner panel 122. Moreover, the inner panel 122 of the cover 106 may include flow channels 128 having different respective shapes. For example, flow channels 128 at or near a central portion of the cover 106 may include a generally symmetrical shape, such as the “H” shape or an “X” shape to spread potting material 126 uniformly from the central portion of the cavity 108, whereas flow channels 128 at edge portions of the cover 106 may include other shapes, such as a “T” shape, configured to direct the potting material 126 toward the central portion of the cavity 108 and/or along the edge portions of the cavity 108.

The RESS assembly 100 also includes a plug 130 that is disposed within the port 118 of the cover 106 after the potting material 126 is injected into the cavity 108 to seal the RESS assembly 100 (FIG. 5). The plug 130 may be a mechanical thermal fastener such as a rivet, a thermal adhesive bonding boss, or something of the like. In one example, the plug 130 may include a composite material that is configured to hermetically seal the port 118 of the cover 106 via friction welding between the plug 130 and the composite material of the core 124 of the cover body 116. That is, after the potting material 126 is injected into the cavity 108 through the port 118, the composite plug 130 may be inserted into the port 118 and joined to the composite core 124 of the cover 106 via friction welding.

In another example, the plug 130 may include a metallic material that is configured to hermetically seal the port 118 of the cover 106 via friction welding between the plug 130 and at least one of the outer panel 120 and the inner panel 122 of the cover body 116. In other words, the metallic plug 130 may be inserted into the port 118 and joined to at least one of the metallic outer panel 120 and the metallic inner panel 122 via friction welding. The metallic plug 130 may be further welded to the outer panel 120 following friction welding.

Further, the plug 130 may include a plurality of plugs 130 corresponding to the plurality of ports 118 at the cover 106. In other words, the quantity of plugs 130 at the RESS assembly 100 corresponds to the quantity of ports 118 at the RESS assembly 100. Further, some plugs 130 may include composite plugs while other plugs include metallic plugs. In this regard, each of the plugs 130 are securely disposed at a corresponding port 118, thus hermetically sealing the cavity 108 from exterior of the casing 102. During manufacture of the RESS assembly 100, the plug 130 is disposed at the port 118 after the potting material 126 has been injected into the cavity 108.

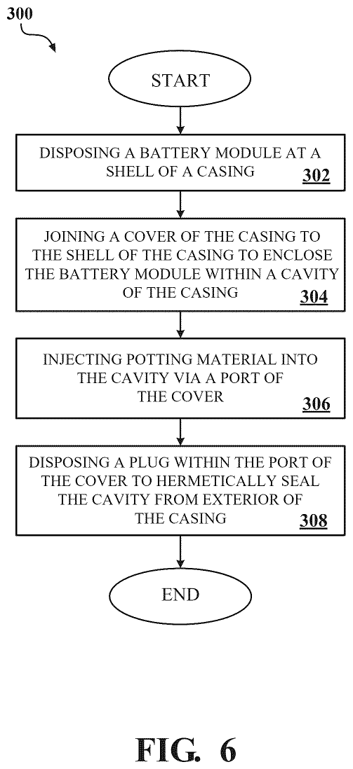

With continued reference to FIGS. 1-5, and with reference to FIG. 6, an example method 300 of manufacturing and assembling the RESS assembly 100 includes, at operation 302, providing the shell 104, the cover 106, and the one or more battery modules 114. At operation 302, the method 300 includes disposing the one or more battery modules 114 in the shell 104. At operation 304, the method includes joining or otherwise attaching the cover 106 to the shell 104, such as via welding, to form the casing 102. For example, the perimeter region 110 of the shell 104 may be joined and sealed to the perimeter region 112 of the cover 106, thus creating an air-tight and water-tight seal between the shell 104 and the cover 106. The battery modules 114 are accommodated within the cavity 108 of the casing 102 between the shell 104 and the cover 106 and sealing the cover 106 to the shell 104 encloses the battery module 114 within the cavity 108 of the casing 102. It should be appreciated that the battery module 114 may be enclosed within a portion of the cavity 108. An empty space or gap of the cavity 108 may extend between the battery module 114 and the cover 106 within the casing 102.

After the cover 106 is sealed to the shell 104 with the battery module 114 disposed within the cavity 108, the method 300 includes at operation 306, injecting the potting material 126 into the cavity 108 through the port 118 via the potting injector 200. The potting material 126 is in a liquid state when the potting material 126 is initially injected into the cavity 108, thus allowing the potting material 126 to freely flow within the cavity 108 and envelop the battery module 114. Further, the flow channel 128, included at the inner panel 122 of the cover body 116 and extending from the port 118, assists in directing the flow of the potting material 126 throughout the cavity 108. The shape and orientation of the flow channel 128 may be configured as desired. Additionally, the shape, orientation, and configuration of the flow channel 128 may correspond to the manner in which the potting material 126 flows within the cavity 108.

At operation 308, after the potting injector 200 ceases injecting the potting material 126 into the cavity 108, such as when the cavity 108 is entirely filled with the potting material 126, the method 300 includes inserting the plug 130 in the port 118. The plug 130 hermetically seals the cavity 108 from exterior of the casing 102. For example, the plug 130 may include a composite material that is configured to hermetically seal the port 118 of the cover 106 via friction welding between the plug 130 and the composite material of the core 124 of the cover body 116. In another example, the plug 130 may include a metallic material that is configured to hermetically seal the port 118 of the cover 106 via friction welding between the plug 130 and at least one of the outer panel 120 and the inner panel 122 of the cover body 116. Hermetically sealing the cavity 108 allows the potting material 126 to expand, cure, and solidify without escaping the cavity 108. Further, hermetically sealing the cavity 108 concurrently seals the battery module 114 within the cavity 108. The potting material 126 may also secure the one or more battery modules 114 within the cavity after the potting material 126 cures and solidifies.

When operating the potting injector 200 to inject the potting material 126 into the cavity 108, the ports 118 may provide reference points or datum points for an optical sensor or sensing system that positions the potting injector 200 at the RESS assembly 100. Moreover, the plugs 130 may provide reference points or datum points for optical sensors or sensing systems during other manufacturing processes, such as during installation of the RESS assembly 100 at the vehicle 10. That is, because the ports 118 and plugs 130 provide relatively high visual contrast compared to the outer surface of the cover 106, optical systems may readily recognize and locate the ports 118 and plugs 130 relative to other portions of the RESS assembly 100. Further, optical sensors or sensing systems may inspect the outer surface of the cover 106 at or near the plugs 130 for leakage of the potting material 126. Because the potting material 126 is injected into the RESS assembly 100 at relatively few positions (i.e., the ports 118) and with the cover 106 already sealed to the shell 104, this allows for faster and simpler validation than typical manufacturing processes where the entire perimeter region of the battery assembly may be visually inspected for leaks.

Additionally, because the potting material 126 is injected into the cavity 108 of the casing 102 after the cover 106 is joined to the shell 104, this attachment may utilize processes without regard for thermal limitations of the potting material 126. In other words, the cover 106 may be joined to the shell 104 using processes that expose the casing 102 to temperatures unsuitable for the potting material 126 as the potting material 126 may be injected into the casing 102 after these processes take place. For example, the cover 106 may be joined to the shell 104 via adhesive that is thermally cured by placing the casing 102 in an oven.

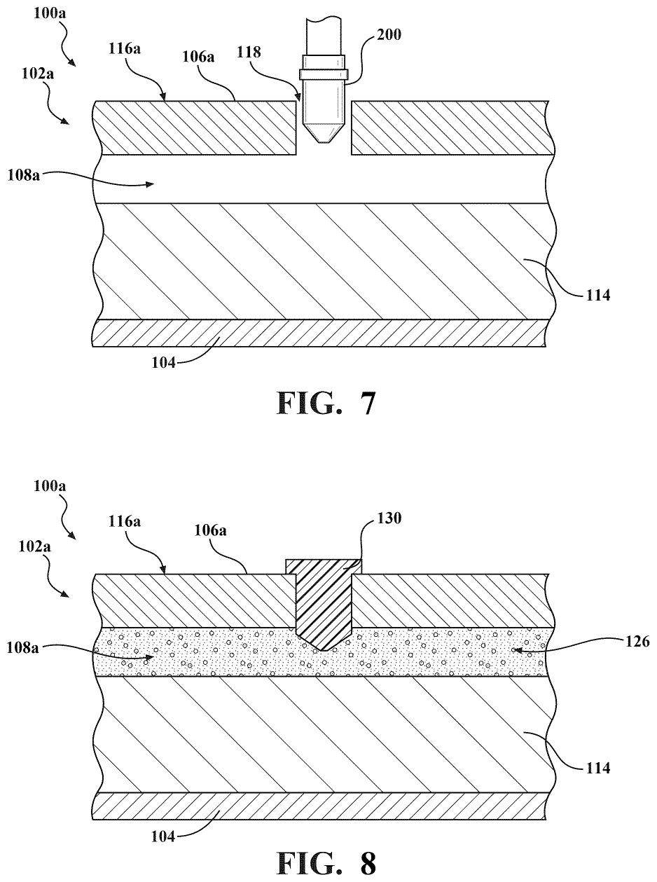

Optionally, the cover of the RESS assembly may include a single material, such as a metallic substrate. For example, and with particular reference to FIGS. 7 and 8, an RESS assembly 100a includes a cover 106a that includes a cover body 116a wherein the cover body 116a solely includes a metallic material and is free of composite material. In view of the substantial similarity in structure and function of the components associated with the RESS assembly 100, like reference numerals are used hereinafter and in the drawings to identify like components while like reference numerals containing letter and number extensions are used to identify those components that have been modified.

The metallic material of the cover body 116a is configured to maintain rigidity and structure of the cover 106a. Further, the cover body 116a is free of panels, cores, and flow channels. As a result, the potting material 126 freely flows non-discriminately within a cavity 108a of a casing 102a when the potting material 126 is injected through the port 118. The cavity 108a adjacent to the cover body 116a that is free of flow channels may be larger than the cavity 108 adjacent to the cover body 116 that includes the flow channel 128. This allows the potting material 126 to sufficiently encapsulate the battery module 114 and flow throughout the entirely of the cavity 108a. Further, the RESS assembly 100a includes a plug 130a that is configured to be disposed within the port 118 of the cover 106a. The plug 130a may be a mechanical thermal fastener such as a blind rivet or something of the like. The plug 130a may include a metallic material that is configured to hermetically seal the port 118 of the cover 106a via mechanical fastening between the plug 130a and the metallic material of the cover body 116a. In this regard, the cavity 108a of the RESS assembly 100a is hermetically sealed from exterior of the casing 102a after the plug 130a is disposed at the port 118.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A rechargeable energy storage system (RESS) assembly comprising:
a battery module;
a casing accommodating the battery module within a cavity of the casing, the casing including a shell and a cover joined to the shell to define the cavity, the cover extending over and along at least a portion of the cavity, the cover including a cover body and a port extending through the cover body and configured to fluidically couple the cavity and exterior of the casing;
a potting material injected into the cavity through the port, the potting material flowing within the cavity and between the cover and the battery module; and
a plug disposed within the port of the cover and hermetically sealing the cavity from exterior of the casing.

2. The RESS assembly of claim 1, wherein the cover body includes an outer panel, an inner panel, and a core disposed between the outer panel and the inner panel.

3. The RESS assembly of claim 2, wherein the outer panel and the inner panel include a metallic material and the core includes a composite material.

4. The RESS assembly of claim 3, wherein the plug includes the composite material, the plug configured to hermetically seal the port of the cover via friction welding between the plug and the composite material of the core of the cover body.

5. The RESS assembly of claim 3, wherein the plug includes the metallic material, the plug configured to hermetically seal the port of the cover via friction welding between the plug and the metallic material of at least one of the outer panel and the inner panel.

6. The RESS assembly of claim 2, wherein the inner panel of the cover includes a flow channel extending from the port for guiding the flow of potting material injected into the cavity.

7. The RESS assembly of claim 1, wherein the cover body includes a metallic material.

8. The RESS assembly of claim 7, wherein the plug includes the metallic material, the plug configured to hermetically seal the port of the cover via mechanical fastening between the plug and the metallic material of the cover.

9. The RESS assembly of claim 1, wherein the port includes a plurality of ports extending through the cover body at discrete locations, and wherein the plug includes a plurality of plugs, each individual plug of the plurality of plugs disposed within a corresponding port of the plurality of ports to hermetically seal the cavity.

10. The RESS assembly of claim 1, wherein the cover is welded to the shell.

11. A vehicle comprising:
a rechargeable energy storage system (RESS) assembly including:
a battery module;
a casing accommodating the battery module within a cavity of the casing, the casing including a shell and a cover joined to the shell to define the cavity, the cover extending over and along at least a portion of the cavity, the cover including a cover body and a port extending through the cover body and configured to fluidically couple the cavity and exterior of the casing;
a potting material injected into the cavity through the port, the potting material flowing within the cavity and between the cover and the battery module; and
a plug disposed within the port of the cover and hermetically sealing the cavity from exterior of the casing.

12. The vehicle of claim 11, wherein the cover body includes an outer panel, an inner panel, and a core disposed between the outer panel and the inner panel.

13. The vehicle of claim 12, wherein the outer panel and the inner panel include a metallic material and the core includes a composite material.

14. The vehicle of claim 13, wherein the plug includes the composite material, the plug configured to hermetically seal the port of the cover via friction welding between the plug and the composite material of the core of the cover body.

15. The vehicle of claim 11, wherein the cover body and the plug include a metallic material, the plug configured to hermetically seal the port of the cover via mechanical fastening between the plug and the cover.

16. A method of manufacturing a rechargeable energy storage system (RESS) assembly, the method comprising:
disposing a battery module within a cavity of a casing, the casing including a cover and a shell;
joining the cover of the casing to the shell of the casing to accommodate the battery module within the cavity of the casing, the cover extending over and along at least a portion of the cavity and including a cover body and a port extending through the cover body, the port fluidically coupling the cavity and exterior of the casing;
injecting potting material into the cavity via the port of the cover, the potting material flowing within the cavity and between the cover and the battery module; and
disposing a plug within the port of the cover to hermetically seal the cavity from exterior of the casing.

17. The method of claim 16, wherein the cover body includes an outer panel, an inner panel, and a core disposed between the outer panel and the inner panel.

18. The method of claim 17, wherein the outer panel and the inner panel include a metallic material and the core includes a composite material.

19. The method of claim 18, wherein the plug includes the composite material, the plug hermetically sealing the port of the cover via friction welding between the plug and the composite material of the core of the cover body.

20. The method of claim 16, wherein the cover body and the plug include a metallic material, the plug hermetically sealing the port of the cover via mechanical fastening between the plug and the cover.
